(19) United States
(12) Patent Application Publication
(10) Pub. No.: US 2010/0013128 A1
(43) Pub. Date: Jan. 21, 2010

(54) APPARATUS, SYSTEM, AND METHOD FOR BLOW MOLDING OF PLASTIC

(75) Inventors: Michael R. Larson, Winchester, CA (US); Raymond L. Larson, Aliso Viejo, CA (US)

Correspondence Address: SNELL & WILMER L.L.P. (Main), 400 EAST VAN BUREN, ONE ARIZONA CENTER, PHOENIX, AZ, 85004-2202, US

(73) Assignee: LARSON TOOL COMPANY, LLC, Carson City, NV (US)

(21) Appl. No.: 12/504,866

(22) Filed: Jul. 17, 2009

Related U.S. Application Data
(60) Provisional application No. 61/135,448, filed on Jul. 19, 2008.

(51) Int. Cl. B29C 49/64; B29C 49/06

(52) U.S. Cl. 264/528; 425/112

(57) ABSTRACT

In various embodiments, devices, systems, and methods for blow molding plastics are provided. In particular, the present disclosure provides for devices, systems, and methods that are configured to create an internal cooling airflow, using conductive and convective cooling thermal properties, such that the cycle time for blow molding plastics is reduced. The decrease in cycle time provided for in accordance with the disclosed devices, systems, and methods are between, approximately 15 percent and 35 percent.

### CROSS REFERENCE TO RELATED APPLICATIONS

This application claims priority to and the benefit of U.S. Provisional Application No. 61/135,448 filed on Jul. 19, 2008, and entitled “Molding cycle enhancer”. The entire contents of the foregoing application are hereby incorporated by reference.

### FIELD OF INVENTION

The present invention generally relates to blow molding plastics, more particularly, to systems, methods, and devices for forming, curing, and cooling blow molded plastics.

### BACKGROUND OF THE INVENTION

Blow molding is a plastic manufacturing process where a molten plastic, also called a parison, is placed in a mold and contacted with a compressed fluid, such that the parison is forced and/or stretched to conform to the mold when it is subjected to a pressure from the compressed fluid. These systems may be used to make a wide variety of plastic products, such as, milk jugs, carbonated beverage bottles, water bottles, watering cans, plastic storage cases, and the like. Blow molded products generally have hollow cavities enclosed within plastic structures, making blow molding an efficient process to produce large volumes of low cost plastic products. Once a blow molding process and system have been designed and built, the ability to decrease the cycle time, that is the time it takes to make a part or lot of parts, makes the blow molding process more efficient and economical.

Typical blow molding systems include a blow stem coupled to a fluid supply, where the fluid supply is usually compressed air at room temperature. The system also includes a melted plastic supply configured to supply a parison to a mold. The mold is generally configured to couple with the blow stem, such that, the fluid supply provided through the blow stem may be applied to the parison to force or stretch the parison to conform to the interior dimensions of the mold.

Typical blow mold systems also include an external mold cooler, such as a bath that provides water to the exterior of the mold, or to internal plumbing that circulates water through the structure of the mold to provide cooling. Generally, after the parison has been stretched or forced to conform to the mold, the parison must cool and harden to retain the shape of the mold. Cooling and hardening of the parison requires that the blow mold system maintain a pressure within the cavity created in the parison by the compressed air, such that the parison continues to conform to the mold until it is sufficiently cool and hard to retain the physical structure of the mold.

These systems present challenges to blow mold plastic manufactures. Specifically, the manufacture must wait for the plastic to cure before removing the formed plastic part from the mold and making another plastic part. Although cure time varies depending on the plastic product being formed, a typical blow mold system that manufactures milk jugs (a approximately one gallon container) can require between, approximately 6.5 seconds and 8.0 seconds to allow the formed parison to cool and harden sufficiently to be removed from the mold. A typical blow mold system that manufactures bleach bottles (an approximately one gallon container) can require between, approximately 14 seconds and 18 seconds to allow the formed parison to cool and harden sufficiently to be removed from the mold. This time spent waiting for cooling slows down the process and is inefficient. As such, there is a need to reduce the cooling time for solidifying blow molded products.

### SUMMARY OF THE INVENTION

The systems, methods, and devices discussed herein in exemplary embodiments of the present invention provide a circulating cooling fluid to the internal cavity of the formed parison such that the formed parison may cool and harden sufficiently to be removed from the tool, in a time that is shorter than the time for a comparable product made without the disclosure of this application. As such, the present invention provides advantages over prior art blow molding systems.

In various embodiments, a device for facilitating internal cooling within a mold during blow molding operations comprises a blow stem and a supply port forming part of the blow stem. The supply port is configured to supply fluid to the mold. The device further comprises an exhaust port forming part of the blow stem. The exhaust port is configured to exhaust fluid from the mold.

In various embodiments, a plastic molding system comprises a fluid supply, a fluid exhaust, and a bidirectional blow stem. The bidirectional blow stem is configured to receive a fluid from the fluid supply and supply fluid to a parison to inflate the parison. The bidirectional blow stem is also configured to exhaust fluid from the parison to the fluid exhaust during cooling of the parison.

In various embodiments a method of making blow molded plastics, comprises the steps of supplying a parison to a mold, supplying a blow stem with pressurized air, and forcing the parison to conform to the mold. Once the parison has conformed to the mold, the parison is allowed to stabilize within the mold. Then a cooling airflow is created within the mold to cool and cure the parison and cool the mold. Once the parison is cured the cured parison (blow molded plastic part) is removed from the mold.

One object of the present invention is to decrease cycle time for manufacturing blow molded plastic products. The systems, devices, and methods disclosed herein enable a decrease in cycle time of at least one second. The decrease in cycle time is provided by the introduction of a cooling air flow to the internal cavity of a blow molded parison. As those skilled in the art will appreciate, the volume of the internal cavity of the blow molded parison effects the decrease in cycle time of the devices, systems, and methods disclosed herein. In particular, the devices, systems and methods disclosed will provide decreased cycle times, between, approximately 10 percent and 35 percent. Various factors dictate the overall decrease in cycle time achieved by the disclosed devices, systems, and methods, including but not limited to, for example, the temperature of the parison, temperature of the supply air, wall thickness of the plastic part being formed, the geometry of the blow molded plastic part, the internal volume of the blow molded parison, the number, size, configuration, and shape of the blow stem(s), flow rate of the cooling fluid flow, the controls in use, the ambient conditions, and/or the like. In one embodiment, the cycle time for blow molding a thin walled one gallon plastic container is decreased by approximately 20 percent.

### BRIEF DESCRIPTION OF THE DRAWINGS

A more complete understanding of the present invention may be derived by referring to the detailed description and claims when considered in connection with the Figures, wherein like reference numbers refer to similar elements throughout the Figures, and:

FIG. 1 illustrates an exemplary block diagram of a blow mold system in accordance with an exemplary embodiment; and;

FIG. 2 illustrates a side-view cross section of an exemplary blow stem in accordance with another exemplary embodiment;

FIG. 3 illustrates a top-view cross section of an exemplary blow stem in accordance with another exemplary embodiment;

FIG. 4 illustrates an exemplary schematic of a blow mold system in accordance with another exemplary embodiment;

FIG. 5 illustrates another exemplary schematic of a blow mold system in accordance with another exemplary embodiment;

FIG. 6 illustrates yet another exemplary schematic of a blow mold system in accordance with another exemplary embodiment; and

FIG. 7 illustrates a block diagram of an exemplary method of blow molding.

### DETAILED DESCRIPTION OF EXEMPLARY EMBODIMENTS

The following is a description of exemplary embodiments of the invention only, and is not intended to limit the scope or applicability of the invention in any way. Rather, the following description is intended to provide convenient illustrations for implementing various exemplary embodiments of the invention. As will become apparent, various changes may be made to methods, structures, topologies, and compositions described in these exemplary embodiments without departing from the spirit and scope of the invention.

In general, systems, methods, and devices are suitably configured to facilitate the production of blow molded plastics. The production may provide for the rapid manufacture of plastic products with hollow internal cavities. Production of blow molded plastics may be facilitated, for example, through use of blow molding and/or blow forming, and in particular though extrusion blow molding, injection blow molding, stretch blow molding and/or the like, such that the production results in a finished plastic part.

For example, the device and/or system may be configured to provide a supply of compressed fluid to a parison such that the parison is forced and/or stretched to conform to a mold. Further, the device and/or system may be configured to exhaust the pressurized fluid from the internal cavity of the parison, while supplying a cooling fluid flow, such that a sufficient internal pressure is maintained to retain the shape of the parison in the mold. The cooling fluid flow may provide convective cooling and/or conductive cooling. This “internal” cooling, in addition to any other cooling that may be used, facilitates faster production of plastic parts compared to processes that do not use internal cooling processes. Once the parison has been sufficiently cooled, the system is configured to expel the plastic part from the mold. Consequently, the production devices, systems, and methods described herein may provide for reduced costs in the manufacture of blow-molded plastics and/or provide for higher production yields of blow molded plastics parts.

Although described herein in the context of blow molded plastics, it should be understood that the techniques described herein may work in other contexts and that the description herein related to blow molded plastics may be similarly applicable to any manufactured product and or system, wherein the product produced has internal cavity formed by contacting the raw material with a compressed fluid such that the raw material is forced and/or stretched to conform to a mold and cooled to cure, in order to retain the shape of the mold.

Blow mold systems exist in various configurations, with a variety of components and performance factors. Nevertheless, an exemplary blow mold system is briefly described here. An exemplary blow mold system may comprise one or more blow stems coupled to a fluid chamber. The fluid chamber may be coupled to a fluid inlet and a fluid outlet. The fluid inlet may be coupled to a compressed fluid supply and a controller, such that the compressed fluid supply is capable of providing a supply of compressed fluid to the fluid chamber in accordance with instructions from the controller. The fluid outlet may be coupled to a control module. The control module may also be coupled to a controller, such that the controller is configured to modulate the fluid outlet. Finally, an exemplary blow mold system may comprise a mold operatively coupled to the blow stem and configured to receive a parison.

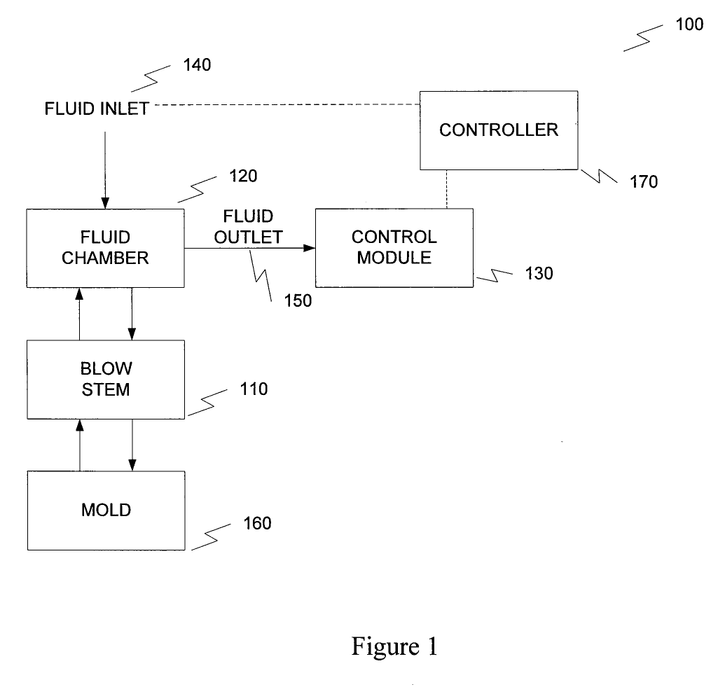

Referring to FIG. 1, and in accordance with an exemplary embodiment, a blow molding system 100 may comprise a blow stem 110. Blow molding system 100 may further comprise a mold 160. Mold 160 may be in fluid communication with blow stem 110.

Blow stem 110 may be any structure comprising a supply port and an exhaust port. In various exemplary embodiments, blow stem 110 may be, for example, a blow pin, a blow stem, a blow needle, a stretch pin, and/or the like. In an exemplary embodiment, blow stem 110 is a bidirectional blow stem. As such, the bidirectional blow stem allows for airflow in at least two directions. Blow stem 110 may be a pair of pipes, tubes, and/or similar structures. Blow stem 110 may be configured to conduct a fluid from a fluid supply through a supply port to a mold. Further, blow stem 110 may be configured to exhaust a fluid from a mold through an exhaust port to a fluid outlet.

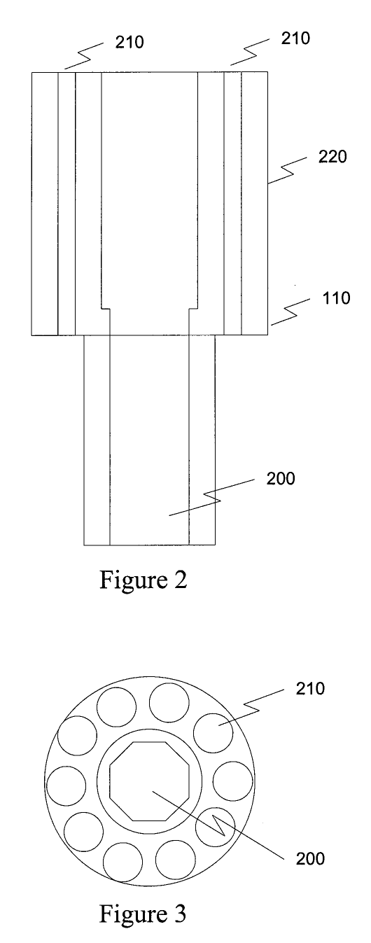

Referring to FIGS. 2 and 3, and in one exemplary embodiment, blow stem 110 may comprise a flange 220, one or more exhaust ports 210, and one or more supply ports 200. Flange 220 may be an annular structure coupled to supply port 200 and configured with one or more exhaust ports 210. In one exemplary embodiment, flange 220 may be configured with any number of exhaust ports 210, for example, one to twelve exhaust ports 210. In one exemplary embodiment, flange 220 may comprise an attachment system, such as a thread, a set screw mechanism, a detent mechanism, a press fit configuration, a configuration suitable for applying a weld, braze, adhesive, and/or the like, and/or similar mechanical, electro-mechanical, and/or chemical attachment systems. The attachment system of flange 220 may be configured to allow blow stem 110 to be removably coupled to a fluid supply. Supply port 200 may be a nozzle, tube, and/or similar structure. Supply port 200 may be in fluid communication with a fluid supply and conduct the fluid supply to mold 160 containing a parison. Stated another way, supply port 200 may be configured to supply a fluid supply to inflate the parison with the mold. Exhaust port 210 may be a through hole, passage, channel, and/or the like. Exhaust port 220 may be configured to exhaust and conduct a fluid from mold 160 to a fluid outlet.

Referring again to FIG. 1, and in accordance with various exemplary embodiments, mold 160 is any structure with an internal cavity having an internal geometry conforming to the exterior of a part to be manufactured. Mold 160 may be in fluid communication with blow stem 110 and configured to receive a parison. As such, compressed fluid supplied through blow stem 110 stretches and/or forces the parison to conform to the internal cavity of mold 160. In an embodiment, mold 160 may have an internal cavity that defines the exterior shape of a plastic part to be blow molded. As such, the internal cavity may take the shape of any plastic part capable of being blow molded, such as, for example, a milk jug, a carbonated beverage bottle, a watering can, a storage container, and/or the like. In an embodiment, mold 160 may be in fluid communication with one or more blow stems 110. Mold 160 may be configured with a cooling system. The cooling system may be a channel contained between the internal cavity and the exterior surface, such that the channel may be configured to transport cooling fluid through the mold. The cooling system may also be a fluid bath, such that the exterior surface of the mold is bathed in a cooling fluid to provide conductive and/or convective cooling.

In accordance with various exemplary embodiments, blow molding system 100 may further comprise a fluid inlet 140, and a fluid outlet 150. Fluid inlet 140 may be any structure suitable for supplying a fluid. Fluid inlet 140 may be, for example, a pipe, a tube, a hose, a conduit, a coupling, a fitting, a valve, and/or the like. Fluid outlet 150 may be any structure suitable for exhausting a fluid. Fluid outlet 150 may be, for example, a pipe, a tube, a hose, a conduit, a coupling, a fitting, a valve, and/or the like. The fluid may be any gas and/or liquid suitable for use in a system for blow molding plastics, such as, for example, air, nitrogen, water, and/or the like. In an exemplary embodiment, the fluid supplied to fluid inlet 150 is air. Although described hereinafter as air, it should be understood that this description is also applicable to other gases and fluids. Fluid inlet 140 may be in fluid communication with blow stem 110 at supply port 200. In one exemplary embodiment, fluid inlet 140 may be configured to supply air to supply port 200, such that, the supply stretches and/or forces a parison to conform to mold 160. In various embodiments, fluid inlet 140 may be configured to supply compressed air at a temperature of between, approximately 65 degrees Fahrenheit and 260 degrees Fahrenheit, where the temperature range provided, is the temperature range of the fluid prior to the air contacting the parison. Moreover, in various embodiments, the temperature of the air supplied to fluid inlet 140 may be any temperature suitable for cooling in parison. Fluid outlet 150 may be in fluid communication with blow stem 110 at exhaust port 210. In one exemplary embodiment, fluid outlet 150 may be configured to exhaust air through exhaust port 210, wherein, a cooling airflow is created within the parison, where the parison has conformed to mold 160.

Referring still to FIG. 1, and in accordance with an exemplary embodiment, blow molding system 100 may further comprise a fluid conduit 120, a fluid control device 130, and a controller 170. Fluid conduit 120 may be operatively coupled to fluid inlet 140 and fluid outlet 150. Further, fluid conduit 120 may be in fluid communication with blow stem 120. Fluid control device 130 may be operatively coupled to fluid outlet 140 and controller 170.

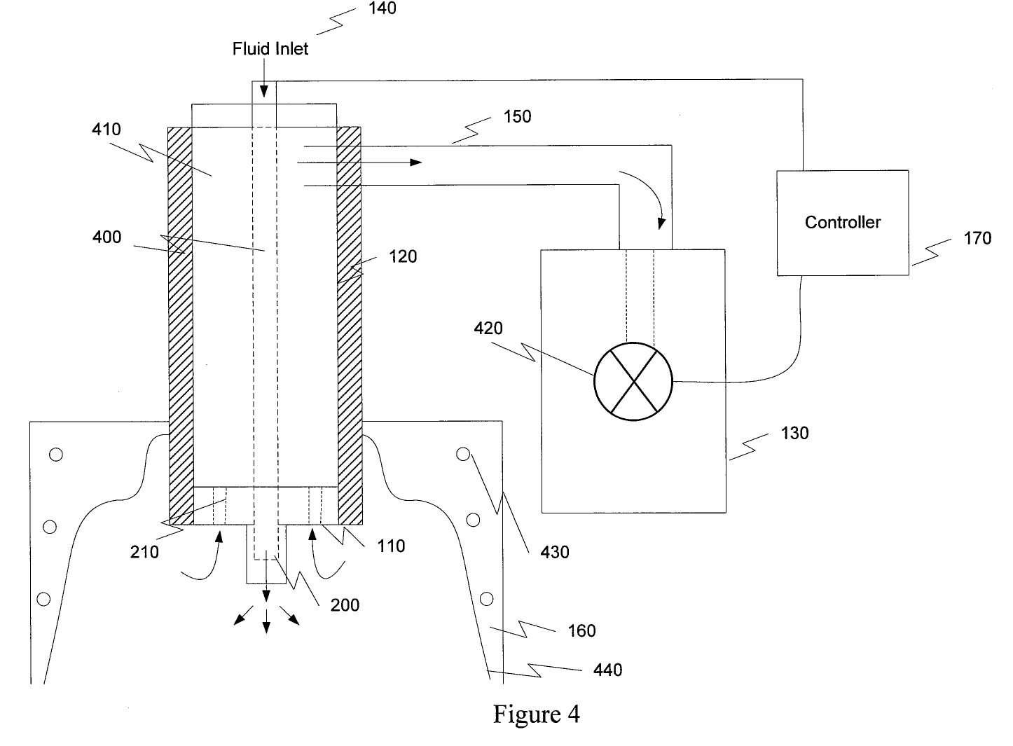

Referring to FIG. 4, and in accordance with various exemplary embodiments, fluid conduit 120 may be any structure capable of conducting and exhausting air to and/or from blow stem 110. In an embodiment, fluid conduit 120 comprises a supply channel 400 and an exhaust channel 410. Supply channel 400 may be in fluid communication with fluid inlet 140 and blow stem 110. In accordance with one exemplary embodiment, supply channel 400 may be configured such that it conducts an air supply from fluid inlet 140 to blow stem 110. Fluid conduit 120 is configured such that air can be supplied to supply port 200 to maintain a pressure within mold 160 for a specified time. Thereafter, the air is exhausted through exhaust port 210. As a result, the exhausted air creates a cooling airflow. The cooling airflow is conducted through exhaust port 210 to fluid outlet 150. The cooling airflow may be managed and/or modulated by fluid control device 130 in conjunction with controller 170.

In accordance with various exemplary embodiments, fluid control device 130 may be any structure capable of directing and/or modulating fluid flow. In an exemplary embodiment, fluid control device 130 comprises a pressure vessel coupled to one or more valves 420. Fluid control device 130 may be coupled to controller 170 and fluid outlet 150. Valve 420 may be a pressure regulator, for example, a flow control valve, a dump valve, and/or the like. Fluid control device 130 may be configured, such that a fluid exhausted through exhaust port 210 and exhaust channel 410 is managed and/or modulated by valve 420. Valve 420 is configured to control the air flow from fluid outlet 150 and exhaust channel 410, such that, a specified pressure is maintained in the parison and sufficient cooling air flow is provided to the parison.

Referring still to FIG. 4, and in accordance with various embodiments, controller 170 may be any structure or system configured to regulate, direct, control, command, organize, manage, and or the like, any variable or monitor-able component of a blow molding system. In one exemplary embodiment, controller 170 may be operatively coupled to fluid inlet 140, fluid outlet 150, fluid control device 130 and valve 420. Controller 170 may be configured to monitor and/or modulate, at least one of fluid inlet 140, fluid outlet 150, and fluid control device 130. Controller 170 may be, for example, a timer, a digital controller, an analog controller, a computer and/or the like. Selection of an appropriate controller will depend on many factors including the number of parameters to be managed and/or monitored, the configuration of variable components, and the outputs provide by monitor-able components, among other factors. In an exemplary embodiment, controller 170 is a JZ10-11-UN20 programmable logic controller and/or a JZ10-11-UA24 programmable logic controller provided by Unitronics, Inc., with an address at 1 Batterymarch Park, Quincy, Mass., 02169.

In various embodiments, the blow molding system may comprise one or more sensors (not shown). The sensors may be any monitoring device suitable for measuring system parameters, such as, for example temperature, pressure, fluid flow rate, and/or the like. The sensor may be operatively coupled to controller 170. Controller 170 may be configured to monitor and/or record data associated with the system parameters monitored by the sensor. As such, controller 170 is configured to control the system parameters by adjusting one or more variable components of blow mold system 100, such as, for example, fluid inlet 140, fluid outlet 150, and/or fluid control device 130.

In accordance with various embodiments, mold 160 may comprise a cooling system 430. In one exemplary embodiment, cooling system 430 may be a channel within mold 160, located between the interior cavity and the exterior surface of mold 160. Alternatively, cooling system 430 may be a water bath. Cooling system 430 may be configured to supply cooling fluid to mold 160. Mold 160 may further comprise parison 440. Parison 440 may be in fluid communication with supply port 200. When fluid is supplied through supply port 220, parison 440 is stretched and/or forced to conform to the surface defining the internal cavity of mold 160. Similarly, exhaust port 210 may be in fluid communication with the internal cavity of mold 160 and fluid control device 130. As such, the blow molding system may be configured to create a cooling airflow in the internal cavity of mold 160 through exhaust port 210 where valve 420 is modulated by controller 170.

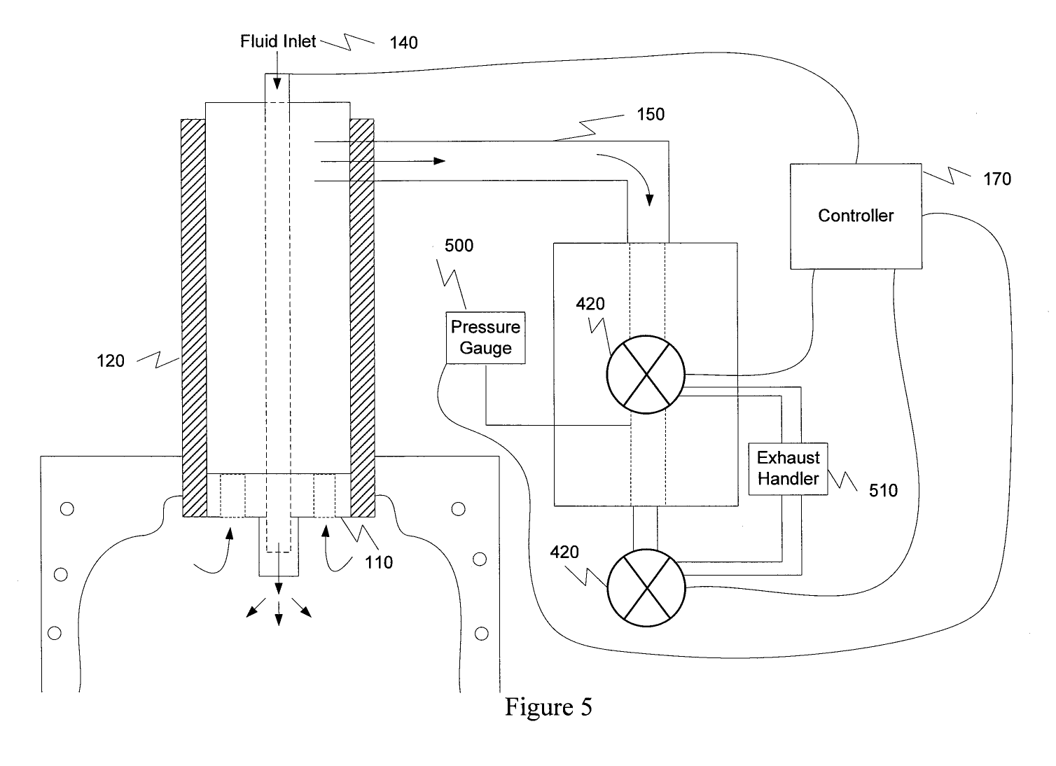

Referring to FIG. 5, and in accordance with an exemplary embodiment, blow molding system 100 may further comprise a pressure gauge 500. Pressure gauge 500 may be operatively coupled to fluid control device 130. Alternatively, pressure gauge 500 may be couple to fluid outlet 150. In either embodiment, pressure gauge 500 may also be coupled to controller 170. Controller 170 may be configured to monitor the pressure measured by pressure gauge 500. Blow molding system 100 may also comprise an exhaust handler 510. Exhaust handler 510 may be operatively coupled to fluid control 420. Exhaust handler 510 may be configured such that air exhausted through fluid control 420 is conditioned by exhaust handler 510. In accordance with various embodiments, exhaust handler 510 may be a muffler, a pressure vessel, and/or the like.

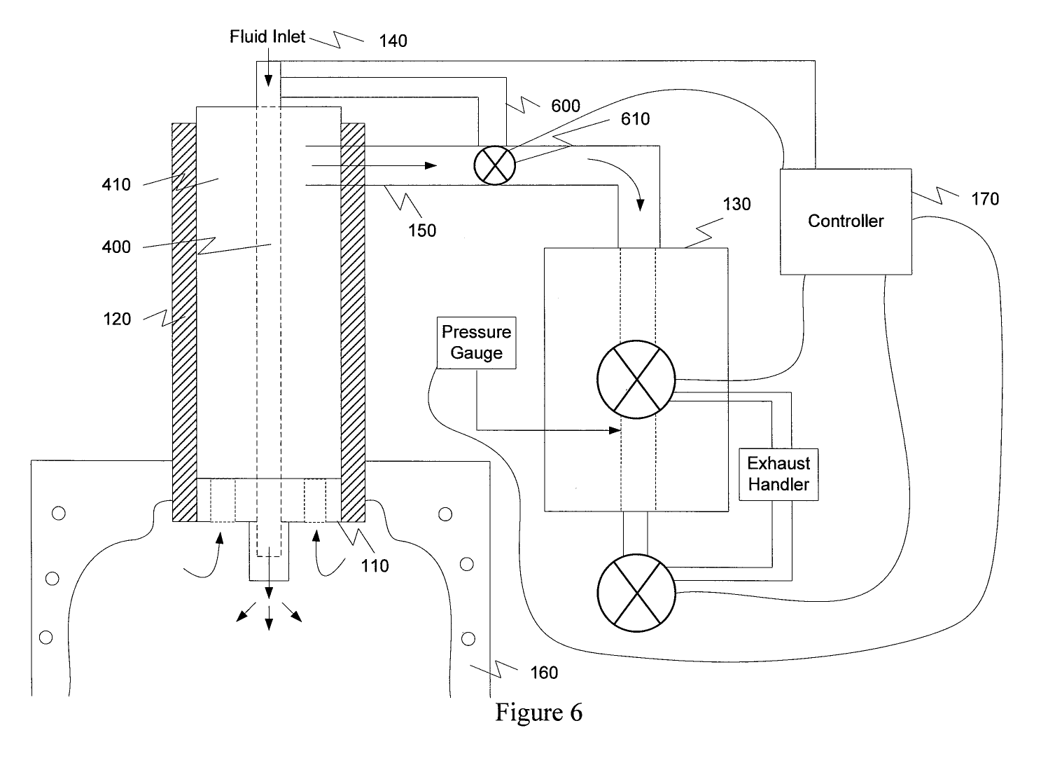

Referring to FIG. 6, and in accordance with an embodiment, blow molding system 100 may further comprise a fluid bypass 600. Fluid bypass 600 may be coupled to fluid inlet 140 and fluid outlet 150. Fluid bypass 600 may further comprise fluid control 610 coupled to fluid outlet 150. Fluid control 610 may be a valve or other fluid control device. Fluid control 610 may be in fluid communication with fluid inlet 140 and fluid outlet 150 and operatively coupled to controller 170. Fluid control 610 may be configured to manage and/or modulate a supply of fluid to exhaust channel 410 through fluid outlet 150 at a specified condition. As such, fluid control 610 is configured to provide supply air through fluid outlet 150 initially. Thereafter, fluid control 610 may be modulated to allow for exhaust flow through fluid outlet 150.

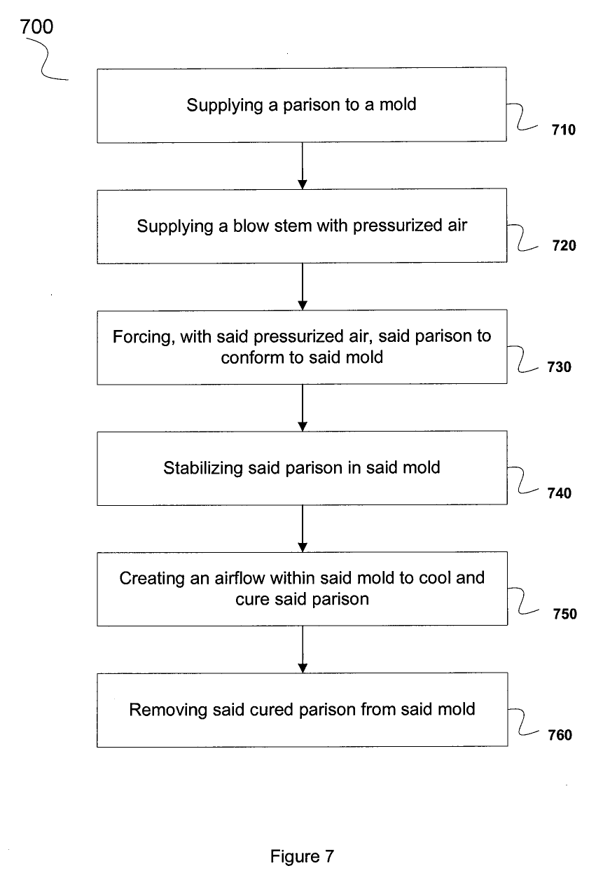

Referring to FIG. 7, and in accordance with an embodiment, blow molding method 700 may comprise supplying parison 440 to mold 160 (step 710). Thereafter, pressurized air is supplied to blow stem 110 (step 720). The pressurized air, forces parison 440 to conform to mold 160 (step 730). Parison 440 is then allowed to stabilize in the mold (step 740). For example, the parison is allowed to stabilize in the mold sufficiently that air circulation within the parison would not cause the parison to deform significantly. Significant deformation would be any deformation outside of acceptable tolerances for the end product. After parison 440 is stabilized, an airflow is created within the internal cavity of mold 160 to cool and cure parison 440 (step 750). Parison 440 can then be removed from mold 160 (step 760). As such, the blow molding method 700 provides for efficient manufacturing of blow molded plastic products.

The present invention may be described herein in terms of functional block components, optional selections and/or various processing steps. It should be appreciated that such functional blocks may be realized by any number of hardware and/or software components suitably configured to perform the specified functions. For example, the present invention may employ various integrated circuit components, e.g., memory elements, processing elements, logic elements, look-up tables, and/or the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, messaging, data processing, network control, and/or the like.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections might be present in a practical blow molding system.

The description of various embodiments herein makes reference to the accompanying drawing figures, which show the embodiments by way of illustration and not of limitation. While these embodiments are described in sufficient detail to enable those skilled in the art to practice the invention, it should be understood that other embodiments may be realized and that logical and mechanical changes may be made without departing from the spirit and scope of the invention. Thus, the disclosure herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the claims that may be included in an application that claims the benefit of the present application, in which reference to an element in the singular is not intended to mean “one and only one” unless explicitly so stated, but rather “one or more.” Moreover, where a phrase similar to “at least one of A, B, and C” may be used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although certain embodiments may have been described as a method, it is contemplated that the method may be embodied as computer program instructions on a tangible computer-readable carrier and/or medium, such as a magnetic or optical memory or a magnetic or optical disk. All structural, chemical, and functional equivalents to the elements of the above-described embodiments that are known to those of ordinary skill in the art are contemplated within the scope of this disclosure.

We claim:

1) A device for facilitating internal cooling within a mold during blow molding operations, the device comprising:
a blow stem;
a supply port forming part of said blow stem, wherein said supply port is configured to supply fluid to said mold; and
an exhaust port forming part of said blow stem, wherein said exhaust port is configured to exhaust fluid from said mold.

2) The device of claim 1, further comprising a fluid supply, wherein said fluid supply is a gas in fluid communication with said blow stem.

3) The device of claim 2, wherein said fluid supply is air.

4) The device of claim 3, further comprising:
a fluid conduit coupled to said blow stem, said fluid conduit having a supply channel and an exhaust channel, wherein said supply channel is operatively coupled to said supply port, such that said supply channel is configured to conduct said air supply and said exhaust channel is operatively coupled to said exhaust port, such that said exhaust channel conducts said air supply to said exhaust port creating an airflow.

5) The device of claim 4, wherein said air supply has a temperature, between about 65 degrees Fahrenheit and 115 degrees Fahrenheit.

6) The device of claim 4, wherein said blow stem comprises a plurality of exhaust ports.

7) The device of claim 1, wherein cycle time of a first system comprising said device is decreased by between, approximately 15 percent to 35 percent as compared to a second system, wherein said second system does not include said device.

8) A plastic molding system, comprising:
a fluid supply;
a fluid exhaust; and
a bidirectional blow stem configured to receive a fluid from said fluid supply and supply said fluid to a parison to inflate said parison and configured to exhaust fluid from said parison to said exhaust channel during cooling of said parison, but before the parison is cured.

9) The plastic molding system of claim 8, further comprising:
a fluid supply conduit operatively coupled to said fluid supply and said fluid exhaust, said fluid supply conduit in fluid communication with said bidirectional blow stem.

10) The plastic molding system of claim 8, further comprising:
a first fluid control device operatively coupled to said fluid exhaust; and
a controller coupled to said first fluid control device configured to modulate said first fluid control device.

11) The plastic molding system of claim 10, further comprising:
a mold removably coupled to said bidirectional blow stem, said blow stem conducting said fluid supply to an interior portion of said mold.

12) The plastic molding system of claim 8, further comprising:
an exhaust handler, wherein said exhaust handler is coupled to said fluid exhaust, such that said exhaust handler is configured to condition an exhaust.

13) The plastic molding system of claim 8, further comprising:
a pressure gauge operatively coupled to at least one of said fluid supply and said fluid exhaust, wherein said pressure gauge is configured to measure a fluid pressure.

14) The plastic molding system of claim 8:
wherein in said fluid supply has a temperature of approximately 65 degrees Fahrenheit to 115 degrees Fahrenheit.

15) The plastic molding system of claim 8, further comprising:
a second fluid control operatively coupled to said fluid supply and said fluid exhaust, such that said second fluid control is configured to remove a fluid supply from said fluid exhaust.

16) The plastic molding system of claim 10:
wherein said controller is at least one of a digital controller, a timer, and an analog controller.

17) The plastic molding system of claim 11, wherein said controller is coupled to said first fluid control, such that said controller is configured to modulate said first fluid control to provide an airflow within said mold.

18) The plastic molding system of claim 17, wherein cycle time of said system configured to provide said airflow within said mold is decreased by between, approximately 15 percent to 35 percent as compared to a second system that is not configured to provide said airflow within said mold.

19) A method of making blow molded plastics, comprising the steps of:
supplying a parison to a mold;
supplying a blow stem with pressurized air;
forcing said parison to conform to said mold;
stabilizing said parison in said mold;
creating an airflow within said mold to cool and cure said parison and said mold;
removing said cured parison from said mold.

20) The method of claim 19, wherein cycle time of said method is decreased by between, approximately 15 percent to 35 percent as compared to a second method of making blow molded plastic that does not include said step of creating an airflow within said mold.
